(19) United States
(12) Patent Application Publication
(10) Pub. No.: US 2007/0006484 A1
(43) Pub. Date: Jan. 11, 2007

(54) Clothes dryer and method for removing odours from textiles

(76) Inventors: Harald Moschuetz, Grossbeeren (DE); Ulrich Nehring, Berlin (DE); Kai Nitschmann, Berlin (DE); Andreas Ziemann, Berlin (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(21) Appl. No.: 10/539,703

(22) PCT Filed: Dec. 16, 2003
(86) PCT No.: PCT/EP03/14356

§ 371 Date: Aug. 14, 2006

(30) Foreign Application Priority Data
Dec. 20, 2002 (DE) 10260151.8

(51) Int. Cl. F26B 19/00; F26B 11/02

(52) U.S. Cl. 34/597; 34/85; 34/60

(57) ABSTRACT

The invention relates to a clothes dryer (1), which comprises a swivel-mounted clothes drum (2) for accommodating and for moving fabrics (4), a processing air channel (5) for supplying processing air into the clothes drum (2) and processing air heating (9) for heating at least the processing air in the clothes dryer (1), whereby the clothes dryer (1) has at least one processing unit (10, 15) for a fluid for generating mist or steam for removing odiferous substances from fabrics (4) and the processing unit (10, 15) is connected to the processing air channel (5). The invention further relates to a process for removing odiferous substances from fabrics in a clothes dryer, whereby fluid is converted into steam in the clothes dryer (1), this steam flows through the fabrics (4) located in the clothes drum (2) of the clothes dryer (1) and moved therein and the steam is carried away with the processing air out of the clothes drum (2).

The invention relates to a clothes dryer and a method for removing odours from fabrics in a clothes dryer.

Fabrics, such as for example items of clothing, become loaded with odours from body odours or environmental influences after a certain period and must be washed or cleaned. To be able to avoid frequent washing or cleaning of such fabrics, which have no visible soiling, and care for the fabrics, it is known to air fabrics, whereby the fabrics can be freed of adhering odours without a washing process. The airing is advantageous in particular for fabrics, which cannot be washed. Manufacturers of laundry chemicals offer systems, in which a moist warm atmosphere is created in a special plastic bag with the aid of a moist cloth, which is soaked in a cleaning fluid, in particular surfactant, when drying in a clothes dryer. This helps to remove odours from the fabrics and the fabrics are also perfumed.

A disadvantage of this type of airing is the relatively extensive handling and the incomplete removal of odiferous substances. In this process the odiferous substances remain in the bag with fabrics and are bound only incompletely by the surfactants contained in the cloth. Additionally, after treatment fabrics can frequently smell unpleasantly strongly of the cleaning agent and additional costs for the cleaning cloth accumulate with each airing procedure.

A dryer device for fabrics is also known from German utility model GM 7341276. The dryer device comprises a water vapour generator, which has comprises a Heating coil for evaporating water in the housing of the water vapour generator. To steam and deodorise fabrics water vapour is conveyed from the water vapour generator via a hose pipe to a box-like housing partially comprising a flexible film, in which fabrics are hung.

The disadvantage of this dryer device is that it must have a highly complex structure to enable uniform distribution of the water vapour in the box-like housing.

The object of the invention is therefore to provide a clothes dryer and a process, by means of which odours can be removed reliably and simply from fabrics. The clothes dryer should also be easy to operate and have a simple structure.

The idea of the invention is that this task can be solved ideally by a clothes dryer and a process, in which water vapour extraction runs directly in the drum of a clothes dryer and supply to the inside of the drum of steam is connected to the processing air conveying.

This task is therefore solved according to the present invention by a clothes dryer, which comprises a swivel-mounted clothes drum for accommodating and for moving fabrics, a processing air channel for supplying processing air into the clothes drum and processing air heating for heating at least the processing air in the clothes dryer, whereby the clothes dryer has at least one processing unit for a fluid for generating mist or steam for removing odiferous substances from fabrics and the processing unit is connected to the processing air channel.

Odours can be removed effectively from fabrics using a clothes dryer of the inventive structure. For one, good intermixing of the processing air with the steam or mist can be achieved by connecting the processing air channel, by way of which processing air is conveyed into the clothes drum, to the processing unit for the fluid, in which steam or mist is produced. In addition, reliable entry and good distribution of the mist or the steam in the clothes drum can be accomplished thereby. Also, protruding contact between fabrics and steam or respectively mist can take place by the fabrics being accommodated in a swivel-mounted clothes drum and being mixed together as the drum rotates. Finally with the inventive clothes dryer and using water as fluid water vapour extraction can take place directly in the clothes drum and the odiferous substances driven out from the fabrics by the water vapour extraction can leave the clothes drum with the processing air.

The connection between the processing unit and the processing air channel can be made by the processing unit being arranged in the processing channel, or is connected to the latter via a preferably very short channel. So as to achieve particularly good intermixing of the processing air with mist or respectively to ensure steam and maximal entry of steam or respectively mist in the drum, the processing unit can be arranged directly in the processing air channel. The processing unit is arranged preferably directly in front of the or in the outlet opening of the processing air channel to the clothes drum. Through this position condensation of the steam or respectively depositing of the mist on walls prior to entry to the clothes drum can be avoided.

In an embodiment the processing unit constitutes an evaporator for evaporating fluid, in particular water. In this embodiment also water molecules in the gas phase are brought with the processing air into the clothes drum. These water molecules can, while the processing air flows through the drum and the fabrics moving therein, bind odiferous substances to themselves and these can be removed from the fabrics.

The evaporator particularly preferably has a heating device, which is formed by the processing air heating of the clothes dryer. The processing air heating, which is used in particular for warming the processing air prior to entry into the clothes drum, is basically already provided in clothes dryers. By using this processing air heating as a heating device for the evaporator a separate component can thus be avoided and the heat energy discharged by the processing air heating on many sides, that is, can be used for warming the processing air and at the same time for vaporising the fluid.

In another embodiment the processing unit constitutes an atomiser. In this embodiment the processing air heating is again used for producing steam, required for the water vapour extraction of odiferous substances from the fabrics. The atomiser delivers a mist, which is introduced along with the processing air into the clothes drum and evaporated there. The atomiser is preferably an ultrasound atomiser. The advantage of using an atomiser is that the process of introducing moisture into the clothes drum can take place at substantially lower temperatures than the boiling temperature of water. The use of atomisers is therefore particularly advantageous with temperature-sensitive fabrics.

The clothes dryer is preferably a clothes dryer of condensate structure and has a water supply pipe from a condensate collection container for supplying the condensation water produced on a condenser to the processing unit. With this configuration of the clothes dryer the introduction of a fluid from outside, such as for example tap water, to the processing unit can be omitted. The condensation water, which normally is collected in condensate collection containers and from there must be disposed of manually, can be reused at least partially in this embodiment, which also eases operating the clothes dryer, since the time intervals in which the condensate collection container must be emptied, can be cut down.

In an embodiment a filter for filtering out odiferous substances can be connected downstream of the clothes drum. “Connected downstream” is understood in terms of this invention as the arrangement of the filter in the direction of flow of the processing air after the clothes drum. But it is also possible that other components, such as for example a condenser and/or a fan is/are provided between the clothes drum and the filter. By using a filter there can be complete removal of odiferous substances, which if required have not accumulated on water molecules and therefore were not separated in the condenser.

Furthermore, the task underlying the invention is solved by a process for removing odiferous substances from fabrics in a clothes dryer, whereby fluid is converted to steam in the clothes dryer, this steam flows through the fabrics located in the clothes drum of the clothes dryer and moved therein and the steam is carried away with the processing air from the clothes drum.

The steam can be produced in an evaporator connected upstream of the clothes drum. Alternatively or in addition mist can be produced in an atomiser connected upstream of the clothes drum, this is conveyed to the clothes drum and steam is produced from the mist in the clothes drum.

The advantages and features for the inventive clothes dryer likewise apply for the inventive process and vice versa.

The invention will now be described hereinbelow by means of the attached diagrams, which represent non-limiting examples of possible embodiments of the invention, in which:

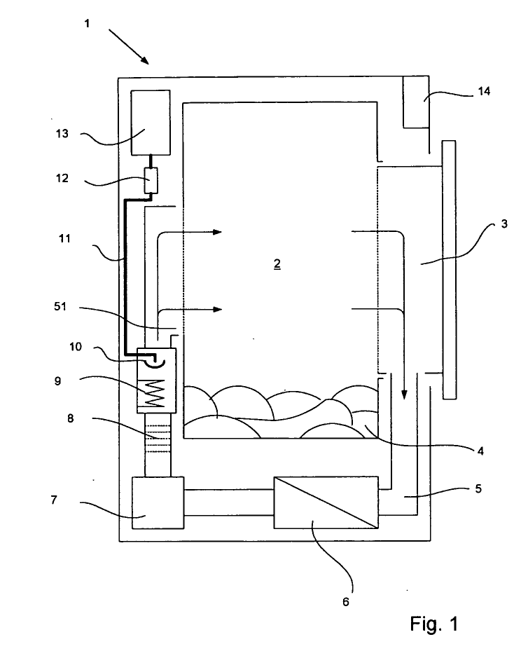

FIG. 1 is a schematic sectional view of a first embodiment of an inventive clothes dryer;

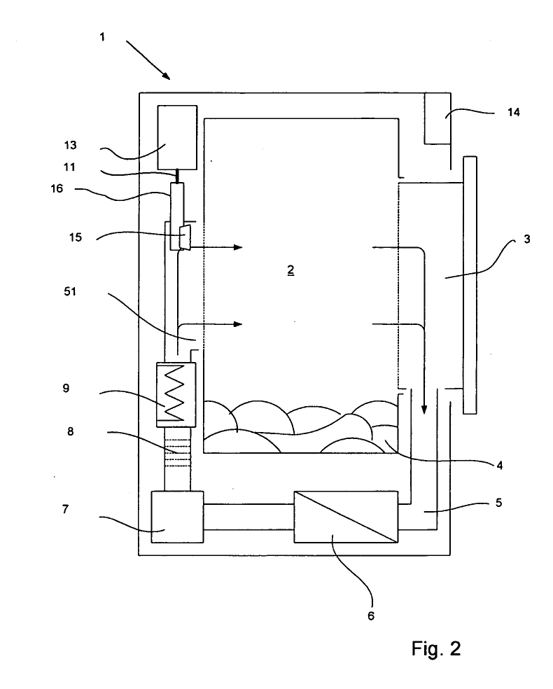

FIG. 2 is a schematic sectional view of a second embodiment of an inventive clothes dryer.

Identical components are provided in the figures with the same reference numerals and are explained once only, if required.

FIG. 1 illustrates a first embodiment of an inventive clothes dryer 1. The clothes dryer 1 is in this case a condensation clothes dryer. In is a schematic sectional view of a first embodiment of an inventive clothes dryer clothes dryer 1 a swivel-mounted clothes drum 2 is provided, which serves to accommodate fabrics, in particular laundry items 4 and can be filed via a fill opening 3 provided on the front of the clothes dryer 1, which can be closed by a door. In the illustrated embodiment in the lower region of the clothes dryer 1 a condenser 6 is indicated. The condenser 6 is arranged in a processing air channel 5. In the illustrated embodiment the processing air channel 5 is a recycling circuit. The processing air channel 5 extends from the lower region of the fill opening 3 via the lower region of the clothes dryer 1 to the rear side, that is the side opposite the fill opening 3, of the clothes drum 2. Connected downstream of the condenser 6 in the processing air channel 5 is a fan 7 to which is attached an odour filter 8. A processing air heating 9 is provided after the odour filter 8 in the course of the processing air channel 5.

In the illustrated embodiment the processing air heating 9 comprises an evaporator 10, which is connected via a water supply pipe 11 and a metering device 12 to a condensate collection container 13. From the processing air heating 9 the processing air channel leads directly to an outlet opening 51 of the channel 5 to the clothes drum 2. This outlet opening 51 preferably has a cross-section widened out relative to the channel 5, so that the processing air can be introduced evenly into the clothes drum 2. The control and regulating of the operation of the clothes dryer 1 occurs via a control and regulating device 14, which can be positioned for example on the front in the upper region of the clothes dryer behind a screen.

The operation and the working method of an inventive clothes dryer 1 will now be explained with reference to FIG. 1.

In normal operation of the clothes dryer 1 moist laundry 4 is put through the fill opening 3 into the clothes drum 2. After actuation of the control and regulating device 14 the drum 2 is rotated and the laundry 4 is thus moved, in particular revolved. The fan 7 is used to put processing air in motion. In particular the processing air is guided along the processing air heating 9 and in warmed form then enters the drum 2, where it flows through the moving laundry items 4 and in the process absorbs therefrom. The moist processing air is guided through the condenser 6, where the moisture is separated by condensation from the processing air. Via a pump (not shown) the condensation water is fed to a condensate collection container 13. After the treated processing air has entered via the fan 7, odiferous substances can be separated in an odour filter 8.

Should the inventive clothes dryer 1 now be used to air fabrics, in particular fabrics which cannot be washed, then by way of the metering device 12 a certain portion of the collected condensation water can be taken out of the condensate collection container 13 via the water supply pipe 11 to the evaporator 10. The water is evaporated there and the resulting water vapour is guided to the clothes drum 2 along with the processing air. In the illustrated embodiment the evaporator 10 is designed with the processing air heating 9 in a single unit. The Heating coil or other heat source of the processing air heating 9 functions in this case therefore simultaneously as heating device for the evaporator 10.

As the mixture of processing air and water vapour flows through the fabrics, odiferous substances adhering to the fabrics are deposited on the water vapour molecules and along with the steam are carried away out of the fabrics. The charged water vapour is then guided out of the clothes drum by the flow of processing air and can be separated at the condenser 6. Odiferous substances still present in the processing air can then be separated at the odour filter 8 connected downstream in the processing air channel 5. Thus the processing air then re-entering the processing air heating 9 is free of odours and can be introduced to the clothes drum 2 for removing odours again along with steam, which is produced in the evaporator 10.

FIG. 2 illustrates a further embodiment of an inventive clothes dryer 1. The clothes dryer 1 has essentially the same structure as the clothes dryer 1 illustrated in FIG. 1, and in particular the clothes dryer illustrated in FIG. 2 is a condensation clothes dryer. In the illustrated embodiment however there is no evaporator provided. Instead of this is a metering device 16 is connected via a water supply pipe 11 to the condensate collection container 13. The metering device 16 cooperates with an atomiser 15. The atomiser 15 is arranged in the upper region of the outlet opening of the processing air channel in the illustrated embodiment.

The operation and the working method of an inventive clothes dryer 1 will now be explained with reference to FIG. 2.

Under normal operation the clothes dryer 1 works in the same way as the clothes dryer 1 illustrated in FIG. 1, as described hereinabove.

If the clothes dryer is used for airing, a certain portion of the condensation water collected in the condensate collection container 13 can be fed to the atomiser 15 via the metering device 16. A very fine-drop mist is produced from the condensation water on this atomiser 15, which can in particular constitute an ultrasound atomiser. This fine-drop mist is blown by the processing air, which flows along the atomiser 15, is mixed with the latter and is blown in the clothes drum 2. At the same time the processing air, which enters the clothes drum 2, is constantly warmed by the processing air heating 9. The very fine-drop mist is thus evaporated in the clothes drum 2, so that a water vapour atmosphere is restored. As the processing air and the steam passes through the laundry 4, which is moved in the clothes drum 2, the odiferous substances adhering to the fabrics are deposited on the water vapour molecules and are carried away along with the steam out of the fabrics. Also in this embodiment filtering of the processing air can take place after separation of the moisture in the condenser.

After air treatment of the fabrics with water vapour they can undergo a further drying process in the clothes dryer in order to remove possibly deposited moisture from the fabrics. In the process the clothes dryer is operated in normal mode, that is, the metering device 12 or 13 delivers no condensation water to the evaporator 10 or respectively to the atomiser 15.

Depending on intensity of the adhering of the odiferous substances to the fabrics the airing process can be repeated with or without subsequent drying process. Appropriate aromatic cloths can be placed in the drum simultaneously with the laundry for the dryer to lend the fabrics an aroma in addition to the removal of smell.

The present invention is not restricted to the illustrated embodiments.

Apart from the condensation structure illustrated in the figures the inventive dryer can also constitute an exhaust air clothes dryer. In this case, instead of the condensate collection container, a fluid reservoir can be provided, which can be filled with water and from which water can be fed to the corresponding metering devices 12 or 16. If this is an aquiferous domestic appliance, in particular a washing machine dryer-clothes dryer combination, the metering device and thus the processing unit for fluid can also be supplied directly from the water supply pipe to the appliance.

The position of the processing unit in the clothes dryer is not restricted to the illustrated positions. This is preferably provided in the rear part of the clothes dryer, that is behind the clothes drum and in the region or in the outlet opening of the processing air channel.

It is also possible to provide separate devices for introducing the mist or the steam to the clothes drum. In the embodiment shown in FIG. 1 the steam generated in the evaporator 10 is mixed automatically with the processing air flowing through the processing air heating. In the embodiment illustrated in FIG. 2 the mist generated in the atomiser is conveyed into the clothes drum both through the atomiser itself and also by the processing air. It is however also possible to provide in the vicinity of the evaporator or the atomiser an additional fan, by means of which the mist or respectively the steam can be blown into the clothes drum.

Other configurations of the arrangement of components in the processing air channel are also covered by the invention. So an odour filter in the processing air channel can be dispensed with, for example, or the filter can be arranged in the direction of flow of the processing air in front of the fan 7. Known filters can be used as filters, whereby a photocatalytic filter is particularly beneficial in the moist atmosphere.

For generating steam, which is fed to the clothes drum for water vapour extraction or is generated there, the heat source of the processing air heating has been used in the described embodiments. But it is also possible to provide a separate heat source. This can serve as heating of air in the clothes drum and thereby can accelerate the evaporation process of mist in the drum. Furthermore, the evaporator can be a separate unit, in which the separate heating device is used for evaporating water. In this case the evaporator is preferably arranged directly in front of the inlet opening of the processing air channel 5 in the clothes drum, so that the steam exiting from the evaporator is mixed with the processing air as it enters the clothes drum 2 and condensing on pipe walls, which lead to the clothes drum 2, can be avoided.

The inventive process can be carried out, after the laundry has undergone a drying process or directly after the laundry was placed into the den clothes dryer. In particular this means that the inventive process can be carried out both on cold and on warm fabrics.

In treating cold fabrics and in particular with fabrics sensitive to temperature, a clothes dryer with a processing unit for fluids generating a mist is of advantage. With this embodiment entry of moisture can take place at clearly lower temperatures than with using an evaporator. In particular entry at temperatures below the boiling temperature of water can occur. With this method though there needs to be monitoring of the moisture in the fabrics, e.g. by the moisture measuring device of the clothes dryer to prevent the fabrics from being wetted.

By using a processing unit for fluid, in which water vapour is produced, fabrics are generally colder than the moist warm air blown into the clothes drum. This can result in deposits of moisture from condensation of steam on water vapour fabrics. As a rule however only slight deposit of moisture takes place without wetting the fabrics.

With the inventive clothes dryer and the inventive process it is therefore possible to remove odours from fabrics simply and reliably, without them having to go through a washing procedure. Also, with the invention additional equipment, such as plastic bags and chemicals, e.g. cleaning chemicals, is not necessary. Finally the inventive clothes dryer has a simple structure and there is the possibility of outfitting conventional clothes dryers to an inventive clothes dryer through slight structural measures.

1-13. (canceled)

14. A clothes dryer, comprising:
a swivel-mounted clothes drum for accommodating and for moving fabrics;
a processing air channel for supplying processing air to the clothes drum and a processing air heater for heating at least the processing air in the clothes dryer; and
a processing unit for removing odiferous substances from fabrics in the clothes dryer, the processing unit processing a fluid and generating at least one of a steam and a mist and the processing unit being connected to the processing air channel.

15. The clothes dryer as claimed in claim 14, wherein the processing air channel includes an outlet opening to the clothes drum and the processing unit is arranged in the processing air channel directly in front of the outlet opening.

16. The clothes dryer as claimed in claim 14, wherein the processing unit includes an evaporator for evaporating fluid.

17. The clothes dryer as claimed in claim 14, wherein the evaporator has a heating device, which is formed by the processing air heater of the clothes dryer.

18. The clothes dryer as claimed in claim 14, wherein the processing unit includes an atomizer.

19. The clothes dryer as claimed in claim 18, wherein the atomizer includes an ultrasound atomizer.

20. The clothes dryer as claimed in claim 14, wherein the clothes dryer is a clothes dryer of the condensate structure and the clothes dryer has a water supply pipe from a condensate collection container for conveying the condensation water generated on a condenser to the processing unit.

21. The clothes dryer as claimed in claim 14, wherein a filter for filtering out odiferous substances is connected downstream of the clothes drum.

22. A clothes dryer, comprising:
a clothes drum receiving fabrics to be treated;
a processing air channel supplying processing air to the clothes drum;
a heater heating the processing air from the processing air channel; and
a processing unit connected to the processing air channel and processing a fluid to add moisture to the processing air from the processing air channel for removing odiferous substances from fabrics in the clothes dryer.

23. The clothes dryer as claimed in claim 22, wherein the processing unit includes an evaporator evaporating a fluid and generating steam to add moisture to the processing air.

24. The clothes dryer as claimed in claim 22, wherein the processing unit includes an atomizer generating a mist to add moisture to the processing air.

25. The clothes dryer as claimed in claim 22, wherein the clothes dryer includes a condensate structure clothes dryer and the processing air channel forms an air recycling circuit having an inlet receiving air from the clothes drum and an outlet discharging the processing air into the clothes drum, the clothes dryer including a condenser connected to the processing air channel and removing moisture from the processing air.

26. The clothes dryer as claimed in claim 25, further comprising a condensate collection container retaining fluid and receiving moisture the condenser removes from the processing air, the condensate collection container being connected to the processing unit and supplying fluid to the processing unit.

27. The clothes dryer as claimed in claim 25, further comprising a filter connected to the processing air channel between the condenser and the processing unit, the filter removing odiferous substances from the processing air.

28. The clothes dryer as claimed in claim 27, wherein the filter includes a photocatalytic filter.

29. The clothes dryer as claimed in claim 22, wherein the clothes dryer includes an exhaust air clothes dryer and the processing air channel includes an air intake for receiving ambient air into the clothes dryer and an exhaust for discharging the processing air after passing through the clothes drum, the clothes dryer including a fluid source supplying fluid to the processing unit.

30. The clothes dryer as claimed in claim 29, wherein the fluid source includes a fluid reservoir retaining the fluid.

31. A process for removing odiferous substances from fabrics in a clothes dryer, wherein fluid is converted into steam in the clothes dryer (1), this steam flows through the fabrics (4) located in the clothes drum (2) of the clothes dryer (1) and moved therein, there absorbs odiferous substances deposited on the fabrics and the steam is carried away with the processing air out of the clothes drum (2).

32. The process as claimed in claim 31, wherein the steam is generated in an evaporator (10) connected upstream of the clothes drum (2).

33. The process as claimed in claim 31, wherein mist is produced in an atomiser (15) connected upstream of the clothes drum (2), this is conveyed to the clothes drum (2) and steam is produced from the mist in the clothes drum (2).

34. The process as claimed in claim 31, wherein odiferous substances are separated out of the steam downstream of the clothes drum by means of a filter.

35. The process as claimed in claim 34, wherein the filter includes an active carbon filter.

36. The process as claimed in claim 34, wherein the filter includes a photocatalytic filter.

37. The process as claimed in claim 31, wherein along with the absorbed odiferous substances downstream of the clothes drum the steam is separated out in a condensation unit.

38. A method for removing odiferous substances from fabrics in a clothes dryer including a clothes drum for receiving fabrics, a processing air channel directing an air flow through the clothes dryer, and a processing unit connected to the processing air channel, the method comprising the acts of:
heating air within the processing air channel with a heater to provide heated processing air;
generating a fluid vapour with the processing unit;
mixing the fluid vapour with the heated processing air to provide vapour and air mixture;
passing the vapour and air mixture through the clothes drum and past the fabrics;
adhering odiferous substances from the fabrics to the vapour and air mixture; and
removing the odiferous substances and the vapour and air mixture from the clothes drum.

39. The method as claimed in claim 38, wherein the processing unit includes an evaporator, and the act of generating a fluid vapour includes providing steam.

40. The method as claimed in claim 38, wherein the processing unit includes an atomizer, and the act of generating a fluid vapour includes providing a mist.

41. The method as claimed in claim 38, further comprising the acts of:
providing a condenser connected to the processing air channel;
passing the odiferous substances and the vapour and air mixture through the condenser; and
removing the odiferous substances and the fluid vapour from the air with the condenser.

42. The method as claimed in claim 41, further comprising the acts of:
providing a filter connected to the processing channel between the condenser and the processing unit; and
removing odiferous substances from the air with the filter.
